(19) United States
(12) Patent Application Publication
(10) Pub. No.: US 2024/0255311 A1
(43) Pub. Date: Aug. 1, 2024

(54) POSITION SENSOR FOR A CYLINDRICAL ROD

(71) Applicant: Hydra Dyne Technology Inc., Ingersoll (CA)

(72) Inventors: Stephan E. BOHNER, Woodstock (CA); Robert KROPINIEWICZ, London (CA)

(73) Assignee: Hydra Dyne Technology Inc., Ingersoll, ON (CA)

(21) Appl. No.: 18/560,533

(22) PCT Filed: May 11, 2022
(86) PCT No.: PCT/CA2022/050738

§ 371 Date: Nov. 13, 2023

Related U.S. Application Data
(60) Provisional application No. 63/188,144, filed on May 13, 2021.

(51) Int. Cl. G01D 5/14

(52) U.S. Cl. CPC G01D 5/145; G01D 2205/14

(57) ABSTRACT

A sensing system for determining axial position of a cylindrical rod involves: a tapered rotatable shaft having a rotation axis, the shaft positionable so that the rotation axis is perpendicular to a translation axis of a cylindrical rod, the shaft having a tapered portion that is frictionally engageable with the cylindrical rod to be rotatable by the cylindrical rod when the cylindrical rod moves axially: a biasing element that biases the shaft in a direction parallel to the rotation axis of the shaft to continually maintain frictional engagement of the tapered portion of the shaft with the cylindrical rod when the shaft is engaged with the cylindrical rod: and, a sensor for detecting rotation of the shaft when the shaft is rotated by the cylindrical rod, the rotation of the shaft being correlated to the axial position of the cylindrical rod.

### CROSS-REFERENCE TO RELATED APPLICATIONS

This application claims the benefit of United States Provisional Patent Application USSN 63/188,144 filed May 13, 2021, the entire contents of which is herein incorporated by reference.

### FIELD

This application relates to determining position of a moveable cylindrical rod, for example cylinder rods in rod-in-cylinder devices, for example fluid-pressure actuators (e.g., hydraulic cylinders) and linear actuators.

### BACKGROUND

In rod-in-cylinder devices, it is often useful to know the axial position of the cylinder rod as the cylinder rod cycles through strokes. Various attempts have been made to provide sensing systems for determining axial position of the cylinder rod. For example, United States Patent U.S. Pat. No. 7,757,547 and Japanese published applications JP 2006226909 and JP 2006258730 all describe arrangements in which a roller is engaged with the cylinder rod to rotate a magnet to induce a signal in an encoder. However, such arrangements invariably suffer from slippage between the roller and the cylinder rod, thereby requiring recalibration of the sensor on an on-going basis. Because the roller is biased to the cylinder rod in a direction toward the axis of rotation of the cylinder, flexion of the cylinder rod in one direction displaces the roller, and when the cylinder rod flexes in a different direction there is a momentary loss of contact between the roller and the cylinder rod causing the position sensor to skip counts leading quickly to miscalibration of the sensing system.

There remains a need for a more robust sensor arrangement for determining a position of a cylindrical rod, for example a cylinder rod during a stroke of the cylinder rod in a fluid-pressure or electrically activated rod-in-cylinder device.

### SUMMARY

A sensing system for determining axial position of a cylindrical rod comprises: a tapered rotatable shaft having a rotation axis, the shaft positionable so that the rotation axis is perpendicular to a translation axis of a cylindrical rod, the shaft having a tapered portion that is frictionally engageable with the cylindrical rod to be rotatable by the cylindrical rod when the cylindrical rod moves axially; a biasing element that biases the shaft in a direction parallel to the rotation axis of the shaft to continually maintain frictional engagement of the tapered portion of the shaft with the cylindrical rod when the shaft is engaged with the cylindrical rod; and, a sensor for detecting rotation of the shaft when the shaft is rotated by the cylindrical rod, the rotation of the shaft being correlated to the axial position of the cylindrical rod.

A sensing system for determining axial position of a cylinder rod comprises: a tapered rotatable shaft insertable into a lateral bore in a head of the cylinder, the shaft having a rotation axis parallel to a tangent to a circumference of the cylinder rod when the shaft is in the lateral bore, a tapered portion of the shaft frictionally engageable with the cylinder rod to be rotatable by the cylinder rod when the cylinder rod moves axially in the cylinder; a biasing element that biases the shaft in a direction parallel to the rotation axis of the shaft to continually maintain frictional engagement of the tapered portion of the shaft with the cylinder rod when the shaft is inserted in the lateral bore; and, a sensor insertable into the lateral bore, the sensor detecting rotation of the shaft when the shaft is rotated by the cylinder rod, the rotation of the shaft being correlated to the axial position of the cylinder rod.

A cylinder comprises: a head; a barrel; a gland; a cylinder rod moveable through a cylinder stroke; and, a sensing system for determining axial position of the cylinder rod during the stroke, the sensing system comprising: a tapered rotatable shaft inserted into a lateral bore in the head, wherein a rotation axis of the shaft is parallel to a tangent to a circumference of the cylinder rod, wherein a tapered portion of the shaft frictionally engages the cylinder rod and wherein axial movement of the cylinder rod during the stroke causes the shaft to rotate about the rotation axis due to frictional engagement of the tapered portion of the shaft with the cylinder rod; a biasing element that biases the shaft in a direction parallel to the rotation axis of the shaft to continually maintain the frictional engagement of the tapered portion of the shaft with the cylinder rod; and, a sensor that detects rotation of the shaft, the rotation of the shaft being correlated to the axial position of the cylinder rod.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts an end view of a hydraulic cylinder comprising a first embodiment of a sensing system for determining axial position of a cylinder rod during a stroke of the hydraulic cylinder.

FIG. 1B depicts a cross-sectional view through A-A in FIG. 1A.

FIG. 1C depicts a cross-sectional view through B-B in FIG. 1B.

FIG. 1D depicts a magnified view of region Y in FIG. 1C.

FIG. 1E depicts a magnified view of region X in FIG. 1B.

FIG. 2A depicts an end view of a hydraulic cylinder comprising a second embodiment of a sensing system for determining axial position of a cylinder rod during a stroke of the hydraulic cylinder.

FIG. 2B depicts a cross-sectional view through C-C in FIG. 2A.

FIG. 2C depicts a cross-sectional view through D-D in FIG. 2B.

### DETAILED DESCRIPTION

Herein is described a sensing system for determining axial position of a cylindrical rod, preferably a cylinder rod of a cylinder. Preferably the cylinder is a rod-in-cylinder device, for example a hydraulic cylinder, a pneumatic cylinder, a linear actuator or the like. The sensing system can be used for determining a stroke position of the cylinder rod in the rod-in-cylinder device. The sensing system comprises a biased tapered rotatable shaft so that the tapered shaft tangentially contacts the cylindrical rod. Axial movement of the cylindrical rod, for example during a stroke of a cylinder-in-rod device causes the tapered shaft to rotate.

The tapered rotatable shaft is biased into frictional engagement with the cylindrical rod by a biasing element. In some embodiments, the biasing element comprises spring, for example a leaf spring, a coiled spring or the like. Preferably, the biasing element comprises a coiled extension spring.

The tapered portion of the shaft tapers between a thicker end and a thinner end. A radial angle of the tapered portion of the shaft is preferably from 3-10 degrees, more preferably 3-7 degrees, yet more preferably 4-6 degrees, for example about 5 degrees. Preferably, the biasing element engages the tapered shaft to continually bias the tapered shaft in a direction of the thinner end so that as the tapered shaft and/or cylindrical rod wears due to the frictional engagement of the shaft with the cylindrical rod, the biasing element advances the tapered shaft to compensate for the wear and continues to maintain the frictional engagement of the tapered portion of the tapered shaft with the cylindrical rod. Once wear causes the biasing element to translate the tapered shaft to an end of the tapered portion or to another predetermined point, the tapered shaft needs to be replaced. However, unlike the devices of U.S. Pat. No. 7,757,547, JP 2006226909 and JP 2006258730, where slippage between the roller and the cylinder rod is a common and recurring problem, the tapered shaft in the present device is strongly frictionally engaged with the cylindrical rod at all times as a result of the tapered shaft being tapered and the biasing element urging the tapered portion of the tapered shaft against the cylindrical rod in a direction tangential to the surface of the cylindrical rod, and/or in a direction perpendicular to the translation axis of the cylindrical rod. Further, when the tapered shaft is used in the head of a cylinder of a cylinder-in-rod device, the cylinder rod at the location of the tapered shaft is constrained from flexing laterally during the stroke, which reduces or prevents slippage of the tapered shaft relative to the cylinder rod. Also, by judicious choice of material for the tapered shaft and providing sufficient length to the tapered portion of the tapered shaft, the sensing system can be used for a much longer period of time before requiring any maintenance or replacement.

The sensing system is provided with a sensor that detects rotation of the tapered shaft. The rotation of the tapered shaft is correlated to the axial position of the cylindrical rod. In some embodiments, the sensor detects rotational position of the shaft and counts a number of rotations of the shaft, the rotational position and the number of rotations of the shaft correlated to the axial position of the cylindrical rod.

In some embodiments, the sensor comprises a magnet mounted to the shaft, the magnet rotating with rotation of the shaft, and a linear encoder in proximity to the magnet so that rotation of the magnet induces a changing electrical signal in the linear encoder. In some embodiments, the linear encoder comprises at least one Hall effect sensing element in which the changing electrical signal is induced by the rotating magnet. The rotational angle of the tapered shaft is thereby correlated to the axial position of the translating cylinder rod to determine the axial position of the cylinder rod. In some embodiments, the at least one Hall effect sensing element comprises a first Hall effect sensing element stacked orthogonally to a second Hall effect sensing element, the first Hall effect sensing element used to determine absolute position of the cylindrical rod and the second Hall effect sensing element used to determine an incremental position of the cylindrical rod. In some embodiments, the magnet has a face that faces the linear encoder. The face preferably has a north pole at first side of the face and a south pole at a second side of the face opposite the first side. In this way, as the magnet rotates with the tapered shaft, the magnet will induce the changing electrical signal in the linear encoder. In some embodiments, the magnet is embedded into an end of the tapered shaft. The magnet is preferably a permanent magnet, although it is possible to use an electromagnet in some embodiments.

In some embodiments, the sensing system is preferably inserted into a lateral bore in a head of a cylinder so that the tapered shaft tangentially and frictionally engages the cylinder rod while the sensor has a portion that protrudes from the lateral bore so that the sensor can be readily coupled to electronic monitoring equipment through an electronic communication element (e.g., an electrical wire or an antenna). The rotation axis of the tapered shaft and a longitudinal axis of the sensor are preferably parallel and more preferably colinear so that a single substantially linear lateral bore can be machined into the head of the cylinder. Such an arrangement facilitates insertion and removal of the components of the sensing system and facilitates servicing the sensing system from outside the cylinder.

The lateral bore in the head intersects partially with the axial cylinder bore that passes through the head of the cylinder so that the outer surface of the cylinder rod partially protrudes into the lateral bore to engage the tapered portion of the tapered rotatable shaft. Further, the tapered shaft has a maximum diameter that is almost as large as a minimum diameter of the lateral bore in the region of the lateral bore in which the tapered shaft is situated without inhibiting rotation of the tapered shaft. Therefore, the tapered shaft is unable to translate laterally past the cylinder rod and the outer surface of the tapered shaft must frictionally engage the outer surface of the cylinder rod as the biasing element urges the thicker end of the tapered shaft toward the cylinder rod.

The tapered rotatable shaft can be inserted into the lateral bore with a thicker end of the tapered shaft closer to or farther from the sensor. When the thicker end of the tapered shaft is closer to the sensor, the lateral bore may be a closed bore having a single opening in the head and a closed distal end because the cylinder rod does not prevent the tapered shaft from being removed out of the single opening when maintenance or replacement is desired. When the thicker end of the tapered shaft is farther the sensor, the lateral bore is preferably a through-bore having openings in the head at both ends of the lateral bore. When the thicker end of the tapered shaft is farther the sensor, having only a single opening in the head would trap the tapered shaft on the distal side of the cylinder rod because the tapered rod could not be moved through the lateral bore past the cylinder rod, thereby requiring opening the entire cylinder to access the tapered rod. Opening the cylinder is often impossible without destroying the cylinder, and would nevertheless be harmful.

The lateral bore is preferably located between a rod seal and a rod wiper in the head of the cylinder because that is generally the cleanest part of the cylinder.

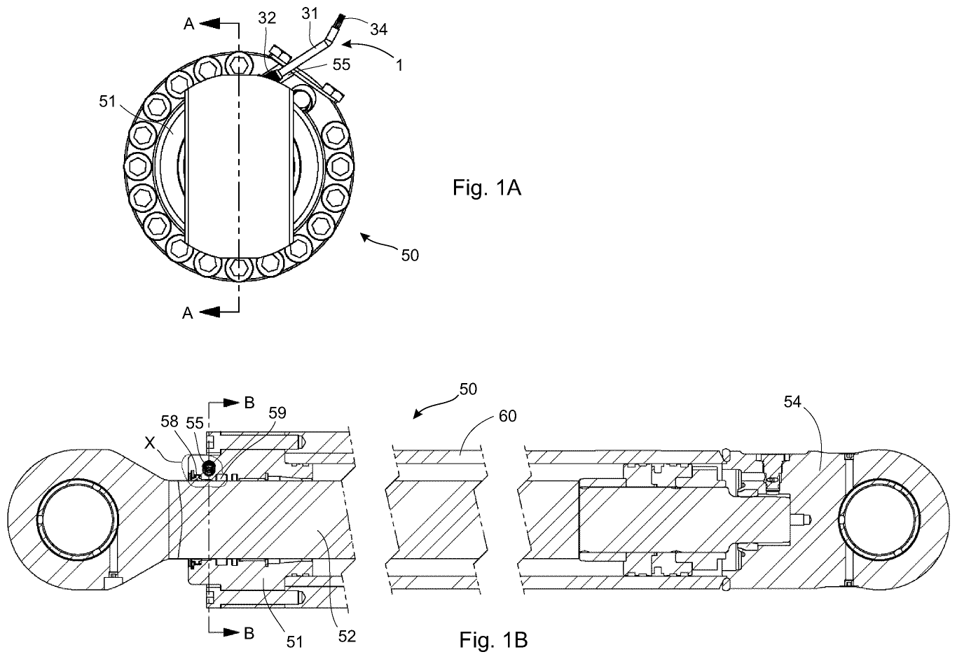

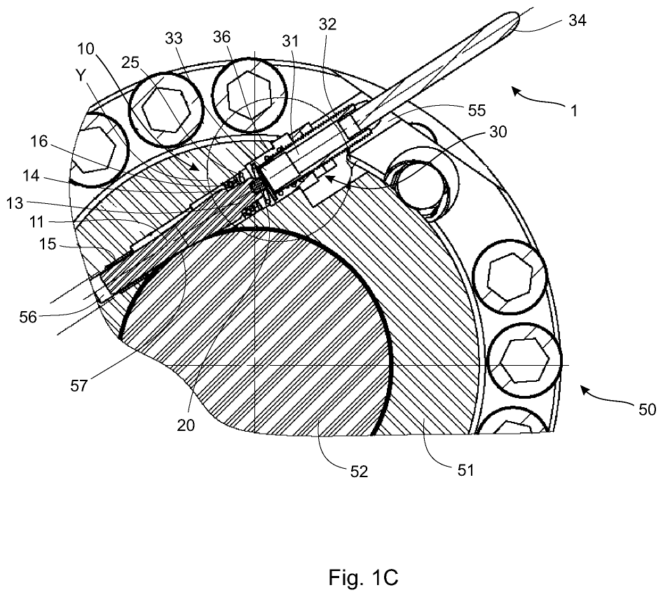

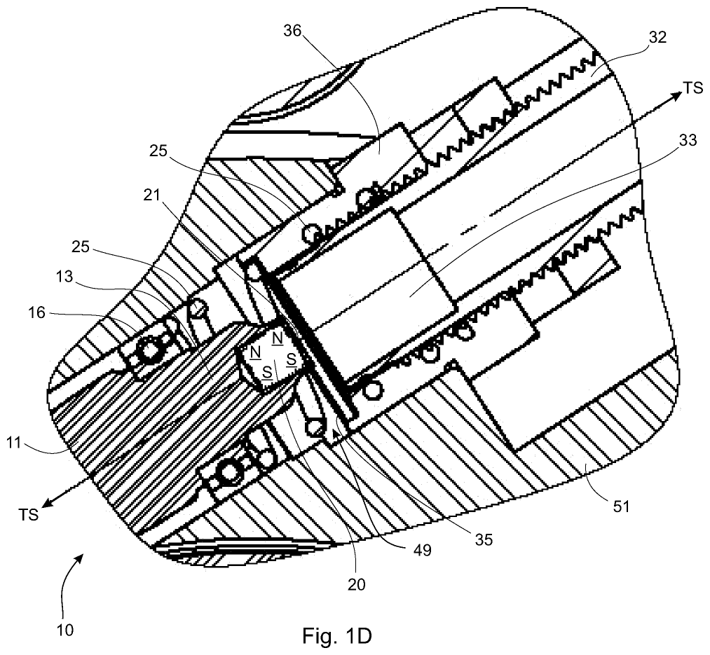

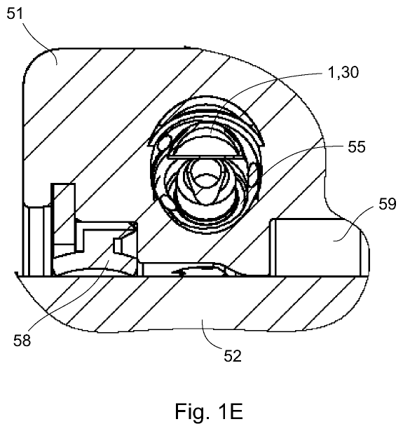

With reference to FIG. 1A to FIG. 1E, a first embodiment of a sensing system 1 for a hydraulic cylinder 50 is illustrated. The hydraulic cylinder 50 comprises a head 51, a gland 54 and a barrel 60 between the head 51 and the gland 54, with a cylindrical cylinder rod 52 disposed in the cylinder 50. The cylinder rod 52 is axially moveable within the cylinder 50 between a rod end and a gland end of the hydraulic cylinder 50 under the influence of hydraulic fluid pressure, the cylinder rod 52 cycling through forward and backward strokes along a longitudinal axis of the cylinder 50. Through a cycle of through forward and backward strokes, the cylinder rod 52 passes through the head 51 and the barrel 60 and into the gland 54. The construction and operation of a hydraulic cylinder, and other rod-in-cylinder devices, is generally known.

The head 51 is provided with a lateral bore 55 extending into the head 51 from an outer surface of the head 51 past the cylinder rod 52 to terminate within the head 51 at a closed end 56. An open portion 57 of the lateral bore 55 is open to the cylinder rod 52, the lateral bore 55 being tangentially oriented with respect to an outer surface of the cylinder rod 52. As best seen in FIG. 1B and FIG. 1E, the lateral bore 55 is located in the head 51 at a rod end of the hydraulic cylinder 50 between an annular rod wiper 58 and an annular rod seal 59. The sensing system 1 is inserted into the lateral bore 55 and comprises two parts, a shaft assembly 10 and a linear encoder assembly 30.

The shaft assembly 10 comprises a tapered shaft 11 made from a suitable material such as stainless steel, the tapered shaft 11 having a tapered portion 12, an outer surface of the tapered portion 12 frictionally engaged with the outer surface of the cylinder rod 52, the outer surface of the tapered portion 12 of the tapered shaft 11 being tangentially oriented to the surface of the cylinder rod 52. The tapered shaft 11 has a longitudinal axis TS-TS (see FIG. 1D) parallel to, and preferably colinear with, a longitudinal axis of the lateral bore 55, the longitudinal axis of the tapered shaft 11 being a rotation axis about which the tapered shaft 11 can rotate. The tapered shaft 11 has a thicker portion closer to an opening of the lateral bore 55 and a thinner portion closer to the closed end 56 of the lateral bore 55.

The tapered shaft 11 is rotationally supported in the lateral bore 55 by a bushing or bearing 15 at a distal end of the tapered shaft 11 proximate the closed end 56 of the lateral bore 55. The tapered shaft 11 is also supported in the lateral bore 55 by a support bearing 16 at a proximal end of the tapered shaft 11 closer to the opening of the lateral bore 55. The tapered shaft 11 is able to rotate on the bushing or bearing 15 and the support bearing 16. The support bearing 16 is seated against a shoulder 14 of the tapered shaft 11, the shoulder 14 being a wider portion of the tapered shaft 11 than a proximal tip portion 13 of the tapered shaft 11. A block magnet 20 is housed in a pocket in an end face of the proximal tip portion 13 of the tapered shaft 11, the magnet 20 crimped in the pocket so that the magnet 20 is retained therein. The magnet 20 has an exposed face 21 facing the opening of the lateral bore 55, with a north pole N and a south pole S being on opposite sides of the face 21 so that a portion of the north pole N and a portion of the south pole S face out toward the opening in the lateral bore 55.

The linear encoder assembly 30 comprises a linear encoder 31 and a retainer coupler 32 and a plug 36 for immovably retaining the linear encoder 31 in the lateral bore 55. The linear encoder 31 is friction fitted in the retainer coupler 32, which is threaded onto the plug 36, the plug 36 and the lateral bore 55 being designed to render the linear encoder assembly 30 immobile once the linear encoder assembly 30 is inserted into the lateral bore 55. The linear encoder 31 comprises a head 33 that houses a pair of Hall effect sensing elements (not shown) stacked orthogonally with respect to each other. The linear encoder 31 is inserted into the lateral bore 55 to provide a small gap 49 between a distal face 35 of the head 33 and the exposed face 21 of the magnet 20. The gap 49 is small enough that the rotating magnet 20 can induce electrical currents in the Hall effect sensing elements in the head 33 of the linear encoder 31. A proximal end of the linear encoder 31 protrudes from the lateral bore 55, the proximal end having an electronic communication element 34 extending therefrom for electronic communication with monitoring equipment.

A coiled extension spring 25 surrounds the proximal tip portion 13 of the tapered shaft 11. A distal end of the coiled extension spring 25 is seated against the support bearing 16 on a proximal end of the support bearing 16 opposite from the shoulder 14 of the tapered shaft 11. A proximal end of the coiled extension spring 25 is seated in the plug 36. The coiled extension spring 25 is under compression when seated between the support bearing 16 and the plug 36. Because the linear encoder assembly 30 is immovably secured in the lateral bore 55, and the support bearing 16 is seated on the shoulder 14 of the tapered shaft 11, the coiled extension spring 25 continually urges the support bearing 16 and therefore the tapered shaft 11 toward the closed end 56 of the lateral bore 55. Continually urging the tapered shaft 11 toward the closed end 56 of the lateral bore 55 continually urges the outer surface of the tapered portion 12 of the tapered shaft 11 toward the outer surface of the cylinder rod 52 so that the tapered portion 12 of the tapered shaft 11 maintains tangential contact with the cylinder rod 52 under sufficient force to increase frictional engagement between the tapered shaft 11 and the cylinder rod 52 to reduce or prevent slippage between the tapered shaft 11 and the cylinder rod 52 during operation of the hydraulic cylinder 50. Further, as the tapered portion 12 wears during use, the tapered shaft 11 is never out of contact with the cylinder rod 52 because the coiled extension spring 25 continually urges the tapered shaft 11 in a tangential direction with respect to the outer surface of the cylinder rod 52, which ensures that a thicker and thicker portion of the tapered portion 12 remains in contact with the cylinder rod 52.

In operation, when the cylinder rod 52 translates axially back and forth between the rod end and a gland end of the hydraulic cylinder 50, the frictional engagement of the cylinder rod 52 with the tapered portion 12 of the tapered shaft 11 causes the tapered shaft 11 to rotate about the rotation axis TS-TS, thereby causing the magnet 20 to rotate about the rotation axis TS-TS. Because the north pole N and the south pole S of the magnet 20 straddle the rotation TS-TS, the relative positions of the north pole N and the south pole S change with respect to the stationary Hall sensing elements in the stationary linear encoder 31, thereby inducing electrical signals in the Hall sensing elements, which are correlated to the axial position of the cylinder rod 52 in a known manner.

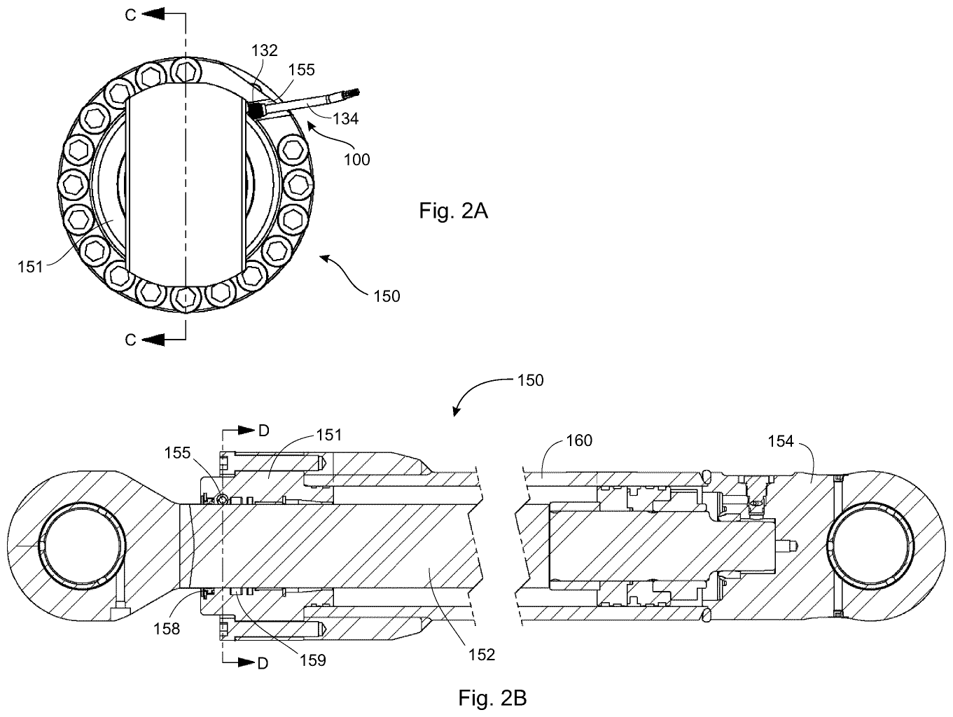

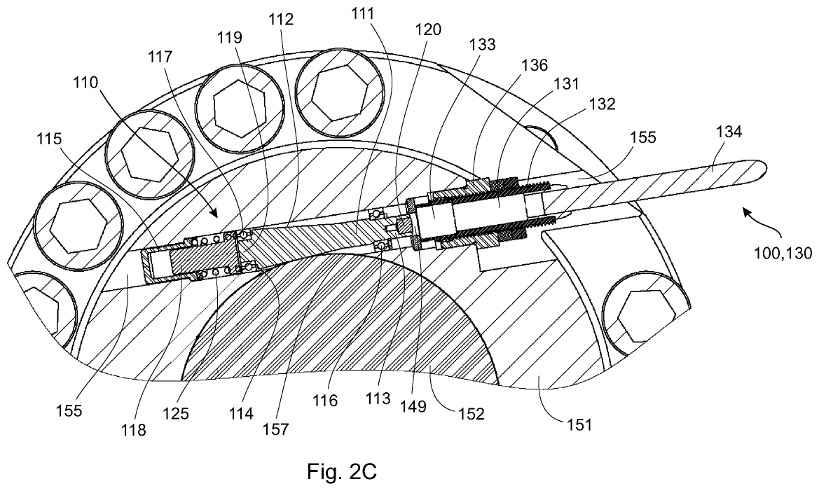

With reference to FIG. 2A to FIG. 2C, a second embodiment of a sensing system 100 for a hydraulic cylinder 150 is illustrated. The hydraulic cylinder 150 comprises a head 151, a gland 154 and a barrel 160 between the head 151 and the gland 154, with a cylindrical cylinder rod 152 disposed in the cylinder 150. The cylinder rod 152 is axially moveable within the cylinder 50 between a rod end and a gland end of the hydraulic cylinder 150 under the influence of hydraulic fluid pressure, the cylinder rod 152 cycling through forward and backward strokes along a longitudinal axis of the cylinder 150. Through a cycle of through forward and backward strokes, the cylinder rod 152 passes through the head 151 and the barrel 160 and into the gland 154. The construction and operation of a hydraulic cylinder, and other rod-in-cylinder devices, is generally known.

The head 151 is provided with a lateral through-bore 155 extending through the head 151 from a first opening in an outer surface of the head 151 past the cylinder rod 152 to terminate at a second opening in the outer surface of the head 151 opposite the first opening. An open portion 157 of the lateral through-bore 155 is open to the cylinder rod 152, the lateral through-bore 155 being tangentially oriented with respect to an outer surface of the cylinder rod 152. As best seen in FIG. 2B, the lateral through-bore 155 is located in the head 151 at a rod end of the hydraulic cylinder 150 between an annular rod wiper 158 and an annular rod seal 159. The sensing system 100 is inserted into the lateral through-bore 155 and comprises two parts, a shaft assembly 110 and a linear encoder assembly 130.

The shaft assembly 110 comprises a tapered shaft 111 made from a suitable material such as stainless steel, the tapered shaft 111 having a tapered portion 112, an outer surface of the tapered portion 112 frictionally engaged with the outer surface of the cylinder rod 152, the outer surface of the tapered portion 112 of the tapered shaft 111 being tangentially oriented to the surface of the cylinder rod 152. The tapered shaft 111 has a longitudinal axis parallel to, and preferably colinear with, a longitudinal axis of the lateral through-bore 155, the longitudinal axis of the tapered shaft 111 being a rotation axis about which the tapered shaft 111 can rotate. The tapered shaft 111 has a thicker portion more distant from the linear encoder assembly 130 and a thinner portion closer to the linear encoder assembly 130.

The tapered shaft 111 is rotationally supported in the lateral through-bore 155 by a first support bearing 116 at the thinner portion of the tapered shaft 111 and by a second support bearing 117 at the thicker portion of the tapered shaft 111. The tapered shaft 111 is able to rotate on the support bearings 116, 117.

The second support bearing 117 is seated against a shoulder 114 of the tapered shaft 111, the shoulder 114 being a wider portion of the tapered shaft 111 than a distal end portion 119 of the tapered shaft 111. A block magnet 120 is housed in a pocket in an end face of a proximal tip portion 113 of the tapered shaft 111, the magnet 120 crimped in the pocket so that the magnet 120 is retained therein. The magnet 120 has an exposed face facing the linear encoder assembly 130, with a north pole and a south pole being on opposite sides of the face so that a portion of the north pole and a portion of the south pole face out toward the linear encoder assembly 130.

The linear encoder assembly 130 comprises a linear encoder 131 and a retainer coupler 132 and a plug 136 for immovably retaining the linear encoder 131 in the lateral through-bore 155. The linear encoder 131 is friction fitted in the retainer coupler 132, which is threaded onto the plug 136, the plug 136 and the lateral through-bore 155 being designed to render the linear encoder assembly 130 immobile once the linear encoder assembly 130 is inserted into the lateral through-bore 155. The linear encoder 131 comprises a head 133 that houses a pair of Hall effect sensing elements (not shown) stacked orthogonally with respect to each other. The linear encoder 131 is inserted into the lateral through-bore 155 to provide a small gap 149 between a distal face of the head 133 and the exposed face of the magnet 120. The gap 149 is small enough that the rotating magnet 120 can induce electrical currents in the Hall effect sensing elements in the head 133 of the linear encoder 131. A proximal end of the linear encoder 131 protrudes from the lateral through-bore 155, the proximal end having an electronic communication element 134 extending therefrom for electronic communication with monitoring equipment.

A coiled extension spring 125 surrounds a ram 118 in the through-bore 155, the ram 118 engaging the distal end portion 119 of the tapered shaft 111. A distal end of the coiled extension spring 125 is seated against a rim of an insert 115 inserted into the through-bore 155, the insert 115 housing the ram 118. A proximal end of the coiled extension spring 125 is against a rim of the ram 118. The coiled extension spring 125 is under compression when seated between the rim of the insert 115 and the rim of the ram 118. Because the insert 115 is immovably secured in the lateral through-bore 155, and the distal end portion 119 of the tapered shaft 111 and the second support bearing 117 are engaged with the ram 118, the coiled extension spring 125 continually urges the tapered shaft 111 toward the linear encoder 130. Continually urging the tapered shaft 111 toward the linear encoder 130 continually urges the outer surface of the tapered portion 112 of the tapered shaft 111 toward the outer surface of the cylinder rod 152 so that the tapered portion 112 of the tapered shaft 111 maintains tangential contact with the cylinder rod 152 under sufficient force to increase frictional engagement between the tapered shaft 11 and the cylinder rod 152 to reduce or prevent slippage between the tapered shaft 111 and the cylinder rod 152 during operation of the hydraulic cylinder 150. Further, as the tapered portion 112 wears during use, the tapered shaft 111 is never out of contact with the cylinder rod 152 because the coiled extension spring 125 continually urges the tapered shaft 111 in a tangential direction with respect to the outer surface of the cylinder rod 152, which ensures that a thicker and thicker portion of the tapered portion 112 remains in contact with the cylinder rod 152.

In operation, when the cylinder rod 152 translates axially back and forth between the rod end and a gland end of the hydraulic cylinder 150, the frictional engagement of the cylinder rod 152 with the tapered portion 112 of the tapered shaft 111 causes the tapered shaft 111 to rotate about the rotation axis, thereby causing the magnet 120 to rotate about the rotation axis. Because the north pole and the south pole of the magnet 120 straddle the rotation, the relative positions of the north pole and the south pole change with respect to the stationary Hall sensing elements in the stationary linear encoder 131, thereby inducing electrical signals in the Hall sensing elements, which are correlated to the axial position of the cylinder rod 152 in a known manner.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A sensing system for determining axial position of a cylindrical rod comprises:
a tapered rotatable shaft having a rotation axis, the shaft positionable so that the rotation axis is perpendicular to a translation axis of a cylindrical rod, the shaft having a tapered portion that is frictionally engageable with the cylindrical rod to be rotatable by the cylindrical rod when the cylindrical rod moves axially;
a biasing element that biases the shaft in a direction parallel to the rotation axis of the shaft to continually maintain frictional engagement of the tapered portion of the shaft with the cylindrical rod when the shaft is engaged with the cylindrical rod; and,
a sensor for detecting rotation of the shaft when the shaft is rotated by the cylindrical rod, the rotation of the shaft being correlated to the axial position of the cylindrical rod.

2. The sensing system of claim 1, wherein:
the cylindrical rod is a cylinder rod of a cylinder;
the tapered rotatable shaft is insertable into a lateral bore in a head of the cylinder, the shaft having a rotation axis parallel to a tangent to a circumference of the cylinder rod when the shaft is in the lateral bore;
the biasing element biases the shaft when the shaft is inserted in the lateral bore; and,
the sensor is insertable into the lateral bore.

3. The system of claim 1, wherein the sensor detects rotational position of the shaft and counts a number of rotations of the shaft, the rotational position and the number of rotations of the shaft correlated to the axial position of the cylindrical rod.

4. The system of claim 1, wherein the sensor comprises:
a magnet mounted to the shaft, the magnet rotating with rotation of the shaft; and,
a linear encoder in proximity to the magnet so that rotation of the magnet induces a changing electrical signal in the linear encoder.

5. The system of claim 4, wherein the linear encoder comprises at least one Hall effect sensing element in which the changing electrical signal is induced by the rotating magnet.

6. The system of claim 5, wherein the at least one Hall effect sensing element comprises a first Hall effect sensing element stacked orthogonally to a second Hall effect sensing element.

7. The system of claim 4, wherein the magnet is a permanent magnet.

8. The system of claim 4, wherein the magnet is embedded into an end of the shaft.

9. The system of claim 4, wherein the magnet has a face that faces the linear encoder, the face having a north pole at first side of the face and a south pole at a second side of the face opposite the first side.

10. The system of claim 1, wherein the biasing element comprises a spring.

11. The system of claim 10, wherein the spring is a coiled extension spring.

12. The system of claim 10, wherein the tapered portion of the shaft tapers between a thicker end and a thinner end, and the spring engages the shaft to continually bias the shaft in a direction of the thinner end so that as the shaft and/or cylindrical rod wears due to frictional engagement of the shaft with the cylindrical rod, the spring continues to maintain the frictional engagement of the tapered portion of the shaft with the cylindrical rod when the shaft is inserted into the lateral bore.

13. A cylinder comprises:
a head;
a barrel;
a gland;
a cylinder rod moveable through a cylinder stroke; and,
a sensing system for determining axial position of the cylinder rod during the stroke, the sensing system comprising:
a tapered rotatable shaft inserted into a lateral bore in the head, wherein a rotation axis of the shaft is parallel to a tangent to a circumference of the cylinder rod, wherein a tapered portion of the shaft frictionally engages the cylinder rod and wherein axial movement of the cylinder rod during the stroke causes the shaft to rotate about the rotation axis due to frictional engagement of the tapered portion of the shaft with the cylinder rod;
a biasing element that biases the shaft in a direction parallel to the rotation axis of the shaft to continually maintain the frictional engagement of the tapered portion of the shaft with the cylinder rod; and,
a sensor that detects rotation of the shaft, the rotation of the shaft being correlated to the axial position of the cylinder rod.

14. The cylinder of claim 13, wherein the sensor detects rotational position of the shaft and counts a number of rotations of the shaft, the rotational position and the number of rotations of the shaft correlated to the axial position of the cylinder rod.

15. The cylinder of claim 13, wherein the sensor comprises:
a magnet mounted to the shaft, the magnet rotating with rotation of the shaft; and,
a linear encoder in proximity to the magnet so that rotation of the magnet induces a changing electrical signal in the linear encoder.

16. The cylinder of claim 15, wherein the linear encoder comprises at least one Hall effect sensing element in which the changing electrical signal is induced by the rotating magnet.

17. The cylinder of claim 16, wherein the at least one Hall effect sensing element comprises a first Hall effect sensing element stacked orthogonally to a second Hall effect sensing element, the first Hall effect sensing element used to determine absolute position of the cylinder rod and the second Hall effect sensing element used to determine an incremental position of the cylinder rod.

18. The cylinder of claim 15, wherein the magnet is a permanent magnet.

19. The cylinder of claim 15, wherein the magnet is embedded into an end of the shaft.

20. The cylinder of claim 15, wherein the magnet has a face that faces the linear encoder, the face having a north pole at first side of the face and a south pole at a second side of the face opposite the first side.

21. The cylinder of claim 13, wherein the biasing element comprises a spring.

22. The cylinder of claim 21, wherein the spring is a coiled extension spring.

23. The cylinder of claim 21, wherein the tapered portion of the shaft tapers between a thicker end and a thinner end, and the spring engages the shaft to continually bias the shaft in a direction of the thinner end so that as the shaft and/or cylinder rod wears due to the frictional engagement of the shaft with the cylinder rod, the spring continues to maintain the frictional engagement of the tapered portion of the shaft with the cylinder rod.

24. The cylinder of claim 13, wherein the lateral bore is located between a rod seal and a rod wiper in the head of the cylinder.
